(19) United States
(12) Patent Application Publication
(10) Pub. No.: US 2007/0204350 A1
(43) Pub. Date: Aug. 30, 2007

(54) Secure Internet

(75) Inventor: Henry E. Juszkiewicz, Nashville, TN (US)

Correspondence Address: WADDEY & PATTERSON, P.C., 1600 DIVISION STREET, SUITE 500, NASHVILLE, TN, 37203, US

(73) Assignee: Gibson Guitar Corp., Nashville, TN (US)

(21) Appl. No.: 11/675,200

(22) Filed: Feb. 15, 2007

Related U.S. Application Data
(60) Provisional application No. 60/774,905, filed on Feb. 18, 2006.

(51) Int. Cl. G06F 17/30

(52) U.S. Cl. 726/30

(57) ABSTRACT

A method is provided for operating a secure communication system, the system including a plurality of devices capable of sending and receiving files. A unique identifier, which may include the MAC address of the sending device, is embedded in each file. A unique file identification is embedded in each file. Purchasers or other rights owners of files are registered in a database via a registration server to establish proof of ownership of rights in the file.

### CROSS-REFERENCES TO RELATED APPLICATIONS

This application is a Non-Provisional Utility application which claims benefit of co-pending U.S. Patent Application Ser. No. 60/774,905 filed Feb. 18, 2006, entitled “A Secure Internet” which is hereby incorporated by reference.

### BACKGROUND OF THE INVENTION

1. Field of the Invention

The present invention relates generally to communication systems and methods of operating the same, and more particularly, but not by way of limitation, to a proposed method for improving the security of the Internet.

2. Description of the Prior Art

A number of proposals have been made for improved techniques for file transfer and for distribution of information over communication systems. As will be seen, while these various proposals each address improvements in one or more aspects of a communication system, none provide the overall comprehensive approach of the present invention.

One system which has been developed by Gibson Guitar Corp., the assignee of the present invention, is that referred to as MaGIC®, which system provides a proprietary protocol for the communication of digital media information. The MaGIC® system is described in detail in U.S. Pat. Nos. 6,686,530 and 6,353,169, the details of which are incorporated herein by reference. A digital media communications and control system includes a plurality of audio devices each of which includes a device interface module for communication of digital media data and control data from at least one of the devices to at least one other of the devices. A universal data link is operatively connected to each of the device interface modules. The device interface modules and universal data links are operative in combination to connect the devices together in the system and provide full duplex communication of the digital media data and control data between the devices. Data is transmitted between MaGIC® devices in the form of discrete, fixed-sized packets or frames at a synchronous rate, preferably using the IEEE 802.3 Ethernet standard. The packet contains networking headers, audio/data, and control information. Each frame is 55 words long and contains the standard Start of Frame, Source and Destination MAC Addresses, Link, words reserved for networking headers, a fixed size data payload, and a CRC field.

A system for incorporation of the MaGIC® protocol in a digital communications and control system for consumer electronic devices used in the home is found in U.S. Patent Application Publication No. 2005/0027888 entitled “Universal Digital Communications And Control System For Consumer Electronic Devices”, of Juszkiewicz, and assigned to the assignee of the present invention, the details of which are incorporated herein by reference. A digital communications and control system for consumer electronic devices used in the home includes a plurality of devices each of which includes a device interface module for communication of digital data and control data from at least one of the devices to at least one other of the devices. The home includes a plurality of network interfaces to which the consumer electronic devices are connected. A universal data link is operatively connected to each of the device interface modules. The device interface modules and universal data links are operative in combination to connect the devices together in the system and provide full duplex communication of the media data and control data between the devices.

Another system developed by the assignee of the present invention is found in U.S. Patent Application Publication No. 2004/0199654 entitled “Music Distribution System” by Juszkiewicz, the details of which are incorporated herein by reference. The application describes systems for distributing music to a plurality of customers via the Internet, which systems provide each customer with a uniquely identified proprietary device for receiving, playing and recording music. A music server computer system is provided for distributing the music to the proprietary devices over the Internet. The system provides for tracking usage of the music on the proprietary devices and reporting the usage data over the Internet to the music server computer system. The system provides for the secure distribution of digital music content over the Internet to consumers in a manner that allows efficient and economical usage of the content by consumers, while providing adequate usage reporting to copyright owners and providing adequate copy protection to prohibit unauthorized usage.

Also a number of digital rights management schemes have been proposed by third parties. One such example is shown in U.S. Patent Application Publication No. 2006/0059560 to Montulli. That publication discloses systems and methods to distribute music by embedding ownership information in a music file; detecting unauthorized sharing of the music file; and determining an owner of the shared music file by decoding the embedded ownership information from the music file.

U.S. Patent Application Publication No. 2001/0051996 to Cooper et al. describes a method and system for transferring electronic media information over a public network in such a way as to provide safeguards for inappropriate distribution of copyright or otherwise protected materials.

U.S. Pat. No. 6,952,685 to Hunter et al. describes a music distribution system and associated anti piracy protection. Music is blanket transmitted (for example, via satellite downlink transmission) to each customer's computer based user station. Customers preselect from a list of available music in advance using an interactive screen selector, and pay only for music that they choose to have recorded for unlimited playback, for example by a CD burner. An ID tag is woven into the recorded music so that any illegal copies therefrom may be traced to the purchase transaction.

U.S. Pat. No. 6,389,403 to Dorak, Jr. discloses a method and apparatus for uniquely identifying a customer purchase in an electronic distribution system. The system provides for tracking usage of digital content on user devices. Content sites for distributing digital content over a computer readable medium to users are disclosed. The content sites associate unique content identifier with the content associated. Electronic stores coupled to a network sell licenses to play digital content data to users. The licenses contain a unique transaction identifier for uniquely identifying the transaction, and the licenses contain a unique item identifier for uniquely identifying at least one item in the transaction. Content players, which receive from the network the licensed content data, are used to play the licensed content data. The content players produce a purchase identifier based upon the mathematical combination of the content identifier, the transaction identifier and the item identifier.

As can be seen from the above, there is a continuing need for improved security in transfer of files over the Internet. The present invention provides a comprehensive system for providing such security.

### SUMMARY OF THE INVENTION

The present invention provides a method of operating a secure communication system, the system including a plurality of devices capable of sending and receiving files. The method includes steps of:
(a) embedding a unique identifier of a sending device in each file sent from one of said plurality of devices to another of said plurality of devices;
(b) embedding a unique file identification in each file sent from one of said plurality of devices to another of said plurality of devices; and
(c) registering a rights owner of a selected uniquely identified file in a database via a registration server to establish proof of rights in the selected uniquely identified file, so that the selected uniquely identified file is associated with the rights owner in the database thereby establishing property rights in the rights owner.

Preferred techniques for embedding the unique identifier of the sending device and the unique file identification in each file are provided.

Preferred techniques for classification of files by format of file content and registering of purchaser or other rights owner and file identification in multiple databases are disclosed.

The combination of elimination of anonymity of sending devices, unique identification of each file and association thereof with authorized users of the files provides a communication system which will substantially deter inappropriate activity.

Also, there is a substantially improved ability to monitor and report volume of usage of particular files of interest.

Accordingly, it is an object of the present invention to provide a secure method of operating a communication system, and particularly of operating the Internet.

Another object of the present invention is to eliminate or minimize abuse of the communication system by identifying the source of inappropriate usage.

Still another object of the present invention is the provision of a system which allows for improved tracking of the volume of file usage.

Another object is to maximize the flexibility of authorized playback devices. Because flexible device usage rights are enabled, more flexibility is awarded to the content owners by assuring appropriate use of material.

Other and further objects features and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a schematic illustration of the secure communication system of the present invention.

FIGS. 2-5 illustrate one method of embedding sender device and file identification information in an extendable header of a data packet. FIG. 2 is a view of a data packet with an extendable header. The first line of FIG. 2 shows the data packet with an extendable header wherein the extendable header has not been extended. The second line of FIG. 2 shows a data packet with the header having been extended by one field. The third line of FIG. 2 shows a data packet with an extendable header having been extended another frame and containing payload information bits. The fourth line of FIG. 2 shows a data packet having been extended by another field and containing payload information bits.

FIG. 3 is a data packet with a tagged frame formatted according to the IEEE 802.1Q protocol. The first line of FIG. 3 shows a data packet with a tagged frame formatted according to the IEEE 802.1Q protocol without any additional tags. The second line of FIG. 3 shows a data packet with a tagged frame formatted according to the IEEE 802.1Q protocol after having added an extra tag. The third line of FIG. 3 shows a data packet with a tagged frame formatted according to the IEEE 802.1Q protocol having added yet another tag.

FIG. 4 is an illustration of a system for utilizing a data packet with an extendable header containing payload information bits.

FIG. 5 is an illustration of an intermediary network device transferring information to a destination device.

### DETAILED DESCRIPTION OF THE PREFERRED EMBODIMENTS

The Ethernet protocol has grown from ubiquitous to the most preferred way to send any kind of information from one source to another. Virtually all computers have an Ethernet port. The communications infra structure reaches all but the poorest and most remote areas of the world. This large usage of this technology has brought the benefit of very low cost hardware. Performance and bandwidth continue to increase rapidly without sacrificing legacy transmission cables and connectors.

There are two fundamental problems present with the Internet. These two very significant problems stem from the Internet's early beginnings as a means of long distance textual communication for a collegial user community. Those problems are that:
1. There is significant abuse of the communication system by anonymous users on the network. This includes illegal sharing of intellectual property, identity theft, virus propagation, malware, e-mail spam and a variety of unwanted intrusive activities; and
2. There are significant quality of service issues when delivering serial streams of information either unidirectional or even more problematically, bidirectional (i.e. low latency real time synchronous behavior). The existing network does not provide for deterministic delivery of data streams.

These two problems can be eliminated by modest changes in the 802.1 standard. The MaGIC® protocol developed by Gibson Guitar Corp., as described in U.S. Pat. Nos. 6,686,530 and 6,353,169 addresses both of these issues and requires changes to the current standard. These solutions are technically easy to implement and preserve backward compatibility.

It is for Consumers, not Businesses

The need for change is driven by the changing nature of how the Internet is being used. The Internet users initially were primarily institutions and businesses. As the network became ubiquitous, the network was used increasingly by consumers, with household penetration growing rapidly in all developed countries. With the advent of Voice over IP, the Ethernet/Internet infrastructure will eventually replace the antiquated telephone infrastructure loading the network with serial streams of data (voice audio) as opposed to packets of text and data.

The ability of this network to deliver consumer media content effectively was proven via music downloads and the growth of peer-to-peer technology. It is clear that distribution of media in files, and increasingly real time streaming will be a continued trend.

It is my contention that addressing the above two problems with simple changes to the standard will:
increase the use of the IP infrastructure,
increase the user experience,
spawn innovation,
expose profit opportunities for equipment makers and service providers; and
allow content owners a robust way of distributing digital content to consumers while minimizing or preventing piracy.
   Lack of Identity Allows Antisocial and Illegal Use of the Internet

The early Internet was relatively small and the users were a tight knit community. The protocol developed to be able to distribute the logistics data load, with very little concern for robust security addressing bad intent. This sense of community and freedom became a sense of social empowerment that early adopters felt strongly should not be infringed.

A very serious problem is that the protocol allows the identity of the node on the Internet to be disguised. Every node on an Internet network is unique and identifiable via its hardware MAC address. Every network interface card (NIC) has this unique hexadecimal number. Indeed, without a unique address, information could not get to where it was going. Unfortunately, while the target address must be known, the sending node does not have to be known, allowing for anonymity. The network infrastructure allows insecure decentralized tables that cross tabulate easy to remember URLs, and IP addresses to hexadecimal hardware MAC addresses (DNS servers). The problem is compounded by the fact the route the data takes can engender multiple hops (going through multiple nodes) from source to destination. This makes it very easy to disguise and hide the sender of information.

When agents can hide their identity, it creates a social situation that encourages outlaw behavior especially if there are profit opportunities. Imagine that anyone could “cloak” their body in clothing that would hide their identity from anyone. Any individual member of society could do whatever they wanted knowing they would not be discovered as the person that did the deed. While most people are moral and would probably not misuse this ability, bad actors clearly would.

I propose that it is absolutely mandatory that the identity of a sending device be securely attached to any information coming from that node, and that that unique identity (which may, for example, include hardware MAC address as well as additional information) be preserved through the entire journey of the information to the destination. This is not difficult to accomplish technically, but would fundamentally alter the security of the Internet cloud. It would remove the cloak that shields the doer of a deed, from the consequences of that deed.

Ownership of Content Requires Unique Identity of the Object Owned

There is one more fundamental problem. This involves the fundamental definition of ownership or more generally of assignment of rights. Physical objects are unique. If I buy a car, there may be many other identical cars, but my car is physically under my control by virtue of having to be in a single location in space. I have to put a unique license plate number on the car with proof that I own it (registration). This process allows the authorities to prove I have complied with all laws governing the vehicle. This process then conveys the right to use the public road system. Should I break the law, the registration data base allows the authorities to find out who I am and where I reside.

The conceptual definition of ownership is the matching of a unique person, with a unique and identifiable asset. Ownership allows society to bestow both rights and obligations to different types of ownership.

Ownership was fundamental to the sale of the entertainment product business models. In years past, it was a matter of a physical person and an object with a physical location. You had to pay an admission fee to see a theatrical production or view a movie in a physical location with controlled access. You bought a physical vinyl disc, or plastic CD. Like my car, these could be identical to other discs, but I possessed mine physically. I owned it.

Technology has allowed content to be removed from a physical container, and essentially become virtual. Increasingly, entertainment content is either a transportable file, or it can be reduced to a transportable file that can pass through an anonymous highway. These disembodiments of content from a physical container, and anonymous roads of travel at the speed of light, have just started to wreaked havoc on legitimate content owners and the historical business models.

A simple but profound solution to this problem is to restore identity to entertainment content by giving every file a unique serial number. This is already increasingly done with commercial software. This identity number would be issued by the seller/creator of the product (file), and would be embedded in the file. This would be done for both files on physical media (such as CDs and DVDs) and files sold virtually (downloads).

The next requirement would be to register the purchase of the now unique content (file) at the point of purchase. This now links a person to the unique product and establishes property rights to the purchasing individual. More generally, the assignment of rights need not be actual ownership of the file and it can be associated with a transaction other than a purchase. The purchaser or person who otherwise acquires rights may more generally be referred to as a rights owner.

Identity, Ownership, Plus Transparency Equal Systemic Integrity and Security

All information that travels over the Internet is in the form of a file going from a source device to a destination device. If we know the source device's unique ID and we know the unique serial number of the file we simply need to add transparency to be able to enforce proper behavior.

Just like your automobile, files traversing the Internet highway would contain a unique identifying number which was issued at the file origination and could be traced back to the owner of the file. Additionally the moving file would contain the unique identifier of the device originating the communication (for example, an embedded MAC address).

The database containing the serial number of the content and the owner's information implies the need for an independent third party to maintain the information on a confidential basis. I propose that organizations already in existence expand their charter to maintain these databases.

This is exactly what happens when we purchase an automobile. We must register the car. We must obtain a drivers license to use the car. In both cases a third party (the department of motor vehicles) maintains the information. The act of registration and licensing confers on us permission to use the car on the nation's roads and highways. Driving without a license or not registering the vehicle is a crime.

The proposed MaGIC® protocol makes secure transactions seamless, and compatible with all legacy equipment. An existing standard like Secure Socket Layer (SSL) could be used to maintain integrity of the information exchange.

Thus the basic rules in a secure Internet as I proposed above are:
1. Any file traveling over an Ethernet network connection from one device to another device will contain an embedded unique identifier of the sending device, which may include the MAC address of the sending device.
2. Every file that exists will also have a unique and persistent identification number embedded in the file and by which transactional activity, usage activity and other relevant meta-data can be maintained during the network existence of the file.
3. The person who purchased that file or is otherwise assigned usage rights to that file would be registered as the rights owner of the file at the purchase site whether it is a physical store or an electronic site. That information would be maintained on a confidential registration site, which establishes proof of ownership of the intellectual property contained therein.
   Local Network Verses Global Infrastructure Cloud

As the IP network becomes even more pervasive and more and more consumer devices connect to the IP net, there will be a bifurcation in the needs and use for Ethernet. There will be a continued proliferation of secure local networks that will be consumer homes. There will also be a continued expansion of the infrastructure cloud linking together these local area networks (LANs). As the local nets increase in number, it is my contention that these local nets will increasingly be used to communicate and share media streams and files inside the secure space, as opposed to home to home, or home to business transmission (LAN to LAN).

MaGIC® does not need to exist in the infrastructure cloud in the beginning. MaGIC® is aimed at the LAN level. We can accomplish the robust security and quality of service (QOS) without requiring massive equipment investments in the infrastructure cloud. The MaGIC® local networks would be able to discern if the information was coming from another MaGIC® network and a protocol like HTTPS used for securing credit card transaction can insure security as the information flow through the insecure infrastructure.

Classification Will Simplify Security and Ease of Use

You might be thinking at this point that there are billions of files and that registration would be burdensome, expensive and maybe impossible. That issue can be addressed by creating classes of files, and classes of devices. This classification structure would be inherent in the specification and allow individual mechanisms to deal with specific types of transactions. Breaking the problems down to specific interactions also allows easy addition of new technologies, devices, and transaction types on a incremental level preserving legacy compatibility.

For example music files can be classified by the format of the content (i.e. wav, mp3, aac, wma, SACD, DVD audio). The consortium of music rights institutions could form an independent organization that would oversee the registration server or servers (one for each format). These institutions already exist and are already tracking music plays in order to be able to distribute royalties to song writers and rights holders. This activity is already taking place in almost every country in the world. In the US the organizations are ASCAP (Society of Composers and Publishers), BMI (Broadcast Music) and SESAC. These organizations do not care about textual e-mail information, or other types of non music files.

Similarly, video content, motion picture content, photo content, and the like could each have a separate server or servers run by independent bodies that reflect that interest. These independent bodies could be regulated by institutions reflecting the consumer's interest, such as a new version of the FCC or perhaps even the FCC in our country.

By breaking up the files into categories the monitoring and data collection task becomes manageable. As new types of files and information develop, new institutions can be formed to address the new developments.

Protection of Privacy Based on Rules, Due Process and Independent Oversight

I anticipate the main objection to such a system of registering and monitoring file use will be the various organizations which advocate rights of privacy. These are indeed very valid concerns in this proposed approach I have two responses.

The first, and in my opinion the most important, is that the entities which manage and own the registration servers are non profit NGO's whose conduct will be regulated by a governmental body. There will be rules of use established by public policy debate and negotiation. These rules of conduct would not allow the disclosure of individuals or what specific content they used or owned without due process. This veil of secrecy would only be lifted if there was a clear indication of fraudulent activity or theft, or by legal mandate of an authorized outside body (court). Rules would be implemented, and those rules disclosed and approved by the regulating body that would trigger a fraud alert. That would then trigger an approved process including disclosure of the alleged bad agent.

Please note that this proposal does not preclude the seller of the file from collecting information on the purchaser in a proprietary data base. I would strongly advocate that the type of information allowed to be collected would be subject to oversight by the same body that oversees the NGO.

The second response I would give to privacy advocate is that this proposed structure is better than many existing situations which have been and are in use and accepted by our citizens. I previously discussed the Motor Vehicle Bureau data bases under the direct control of a government agency. There are credit databases that have no formal government oversight, no due process, and do not allow public forums and discussions of consumer rights. There are medical records both for consumers and medical practitioners with similar lack of protection and oversight; consider employee record databases, and the list goes on and on. In fact, in the recent past, many databases have been compromised due to sloppy practices on the part of the administrator of the database.

I propose a robust formal process that protects the rights of consumers with rules determined and overseen in a public forum. Ultimately statistics on the use of entertainment media does not seem to me to be nearly as concerning as my personal financial information, creditworthiness, or medical condition/procedures. Yet that information lacks the proposed protection against misuse.

Media Research

I propose that in addition to registering the purchase of or other acquisition of rights in content, any transmission, or movement of a file trigger a notification transmission to the relevant registration server. A small bullet of information would go this server with the ID of the file, the device ID and the LAN ID (typically the MAC of the router interfacing to the Internet cloud—i.e. cable modem). Thus if a DVD is played, the bullet zings out with the MAC address of the DVD player, the LAN MAC and the file Serial Number. If a file is transferred or copied to an iPod, the bullet zings out with MAC address of the iPod player, the LAN MAC and the file Serial Number.

The institution that administers the registration server can do two very valuable things:
1. It can automatically run rules to detect a high probability of fraudulent behavior; and
2. It can tabulate the number of times entertainment media is experienced by consumers.

Note that the registration server does not have the actual name of the individual. That information would be outside of their data base, further protecting the privacy of consumers. When a fraud alert is triggered, the information would be forwarded to the Intellectual Property owner (unique file ID and the device identifier of player device, and the LAN MAC). Presumably, the IP owner has a record or the serial number of content file, and the name of the purchaser. The ISP would have to provide the name of the LAN owner independently, and with some due process provision.

The second use would allow a revenue stream to support the registration organization through the sale of “ratings” a la Nielsen, although in this case much more accurate. This would make the scheme self funding. This information would allow rights organization like ASCAP, BMI and SESAC to be able to pay rights holders much more efficiently. It would also benefit consumers. The information would allow media producers a much more accurate indication of what consumers want, and it would enable them to create content that better met consumer needs.

Note that this process would extend to shows (files) received from broadcast sources. The owner would be the broadcaster (local TV station, web caster, local cable provider, etc.) The shows that actually were transmitted from the source device (i.e. cable box or tuner) to the playing device would send out a bullet. Commercial broadcasters would treat the commercials inserted as separate files. If the content was moved to a device that stores the content (i.e. TiVo) the bullet would fly to the registration server. When the content was then sent to the playback devices, bullets would fly. If the commercials were skipped over, no bullet would fly and for the first time there would accurate information on commercial viewership.

Storage is the Key—Lock Storage to the Mac Address

The key to security is being able to control what files enter your device and/or transfer to your storage media. People can not walk into your home secretly and leave items or take items. With the current infrastructure (operating systems, network protocols) there is inadequate provision for user control of files on their storage media. Rogue processes can alter or remove files without user knowledge. Note that files can be executable, and do not just represent static information like music.

The key to security is to have both unique device ID and unique file identification. If each physical storage device had a unique serial number and “locked” to the MAC address of the device in which it resided, we would gain the benefit of integrity and authentication. Thus, any action involving a file change, addition or removal would go to the appropriate registration servers with the device ID, and the file ID.

The same would happen if a process intrusively embedded an executable or a virus in a file we purchased. That would send a bullet that the purchased/owned file had been altered, and send the ID of the device node. Should that altered file propagate, the originating device, and subsequent nodes receiving and distributing the content would be registered. Even if the originating rogue was able to falsify the original sending info the acquiring site would register the activity and could trigger fraud rules and well as a chain of custody of the file stopping innocent propagation.

If any files are added, changed or removed a server outside your internal system can trigger a fraudulent activity report. These servers could be paid services like antivirus companies, or the company who sold you the software and is responsible for its specific operation.

This ability to ubiquitously monitor file movement and changes would shut down rogue activity on the network.

All Devices Will be on the Net

If the network becomes both secure and easy to use for users and owners of the intellectual property (users are the largest body of owners of their own intellectual property—i.e. personal photos and compositions), there is a tremendous incentive to put all devices with a role in communicating information on the net. Today the net is principally about computers, with a very few Consumer Electronic devices online. With the solution of the problems of security, and quality of delivery of high bandwidth streams, the net becomes the ideal transport mechanism for all consumer devices.

This will allow both the ability to transmit info, and access info from any device in the home to any other device. You can access your TiVo in the den and watch it on your plasma tv in the bedroom. You can view info from any of your security cams on any screen you are at. Every thermostat is available for control even from outside the home. The ability to buy content and use it in different locations in your personal life is compelling. A central library of personally owned (and paid for) content will be a reality. The secure system of the present invention will expedite this growth.

It is also anticipated that fair use rules will be established in a public forum with input by all concerned groups. This system allows a comprehensive and robust enforcement of those fair use rules once established without burdening consumers, equipment makers or rights holders.

MaGIC® will Allow Ease of Use and Broad Access to Content you Own

If all devices, most notably all consumer electronic products, exchanged information via a highly secure network as proposed herein, manufacturing costs would go down significantly, devices would be much easier to use and the quality of the user experience would increase.

This can be illustrated using an example of a common scenario in the home.

Today, most homes have a DVD player. This consumer device sends information to another consumer device, typically a plasma screen. The plasma screen has several different kinds of connectors on the back of the device, with different quality (composite, component, HDMI, DVI, etc).

The DVD video information must be decoded in the player. Decoded video is then sent to the screen. The decoded signal is very high bandwidth requiring expensive wire(s) which degrade the signal with distance. DVD audio is typically sent to an AV receiver in encoded form and decoded in the receiver. The AV receiver has different inputs as well (optical, coaxial, RCA phono, etc.) The user needs to tell each device which input to use, and often what specific standard to use. Finally the DVD player only sends its content to one video play back device and one audio playback device.

In the MaGIC® home, the devices are all on the home network which is accessible in every room via an RJ45 connector. MaGIC® requires devices to broadcast their specific controls parameters and operation mode choices. Strong device defaults and low level device memory allow quick intuitive connectivity. Thus you plug the plasma screen into RJ45 wall plug that is close, and likewise the AV receiver and the DVD player. Once plugged in, you can play a movie with the best quality set up in just a minute. That mode is remembered and serves as a default. One connection, no manual.

That plasma can also receive information from any other device: the security system, the home computer, the iPod, etc. It is easy to access YOUR information anywhere.

All devices will need only two connectors—an RJ45 network plug, and a power cord. The MaGIC® LAN protocol is completely compatible with the Ethernet standard (IEEE 802.1) which allows seamless connection to the outside world and wireless devices in the home.

MaGIC® has a classification system for devices which allows ease of set up. MaGIC® also requires a device to communicate its capabilities to the system. Thus a DVD player is a play back device (transmitting), the Plasma screen is video viewing (receiving device), and the AV receiver is an audio sound device (receiving device). If these are the only components in a system, once plugged in to the net, it auto configures (plug and play).

The classification scheme with the required memory registers in the device allow the system to self configure quickly and learn your most used modes. This allows you to do everything you want in seconds.

The current 1 gigabit per second Ethernet of Category 5 wire is sufficient to carry home computer network information, high definition video, Blu-ray HD video, security camera info, audio and control information simultaneously over an entire home. The next expansion of Ethernet of cable is 10 gigabits and is already in development allowing even professional level LANs.

The Need for Quality of Service is Driven by Video and Audio Device Use

The need for quality of service in the home LAN will be driven by consumer electronic products in the home. Because the network will allow the media streams to be routed simultaneously over the entire LAN, the need to deliver signals with very low latency will be critical to the user experience. Small time differences or glitches, which are acceptable in a contention based Ethernet system, will be obvious and unacceptable in the home.

There is already a pervasive movement towards using Ethernet to distribute (stream) entertainment content throughout the home. As this happens the need to QOS is apparent, and MaGIC® is the most comprehensive and best performing solution.

This future world will create two demands that are not currently addressed by the CE industry.

The first is the need to keep the amount of information transmitted over Ethernet to be minimized to allow optimum network performance and bandwidth for the multitude of streams that will be transmitted. On a simple level this means that content that is compressed (such as DVD discs, HD-Discs) be transmitted to viewing and listening devices in the native compressed format (i.e. AC3, or MPEG2). The decoding of this signal at the end device will improve the quality the user experiences, and allow the ease of set up illustrated above. It will also reduce the cost of the set up both for the manufacturer and the user.

The second need is to have a rationing of the bandwidth for low latency synchronous signals, verses signals which do need this quality of service. Thus current uses of Ethernet (e-mail, browsing, etc) do not have to change in any way. This rationing will take place for a specific signal path, from one to device to the other device, allowing full use of the rest of the net as needed.

No Ethernet Connection, no Problem

What if your home did not have a network or the local network was not connected to the Internet cloud? Devices could still use category 5—RJ45 cables to connect to each other on a point to point basis, or using very inexpensive hubs to connect a few components. There could be many such mini LAN's which would operate regardless of a connection to the Ethernet cloud.

Of course, this would prevent the content use bullets from reaching their registration servers. However, this would also mean files could not come from the Internet, or be shared or changed via an Internet process. All devices could contain buffers and a routine that could deal with intermittent connection to the Internet to try to defeat registration.

Penetration of the Internet in home continues to accelerate. 70% of US households already connect to the Internet. Even without the enticement of MaGIC® and easier to use CE devices, household penetration will reach well over 90% by 2010 with broadband reflecting over 80% penetration. With the proposed benefits of MaGIC®, this penetration will accelerate.

For an intermediate period, a home hub/switch can be designed to call toll free numbers and transmit bullets nightly.

Prevention Flag—No Encryption

One other detail of this proposed scheme, is the inclusion of a play prevention flag in every device that plays back content. This flag could be set by a message from an appropriate registration server, and trigger a message to call the registration organization to reset the flag. There would be a 24 hour/7 day toll free number to call.

This flag could also be set if the device had an intelligent algorithm predicting fraud.

In both cases, strong preventive measures could be taken without the need to encrypt content.

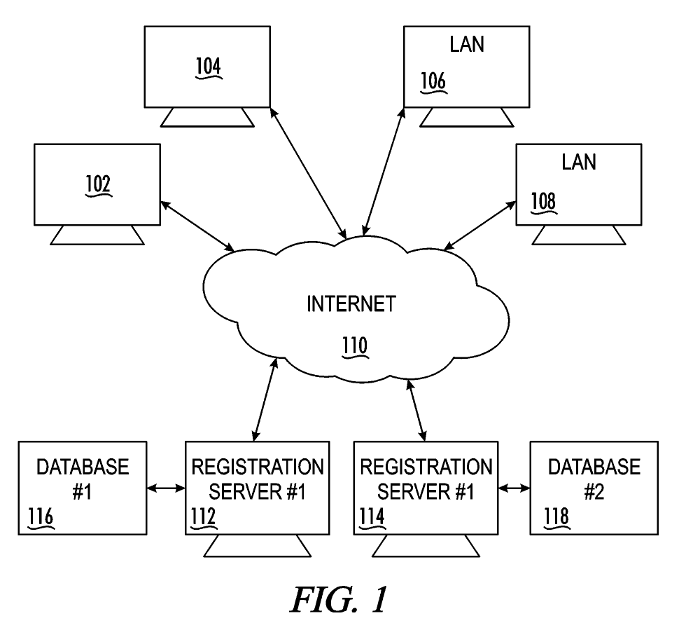

The System of FIG. 1

FIG. 1 schematically illustrates and summarizes the secure communication system of the present invention which is generally designated by the numeral 100. The system 100 includes a plurality of devices 102, 104, 106 and 108, each of which is capable of sending and receiving files. Some of the devices, such as is indicated for devices 106 and 108 may be representative of local area networks which are in turn made up of multiple devices. The devices may communicate with each other over a global communication network such as the Internet indicated by the Internet cloud 110. The system 100 will also include a plurality of registration servers such as 112 and 114 which communicate with the devices 102 through 108. Each of the registration servers 112 and 114 will have an associated database 116 and 118, respectively.

In the use of the present system, a unique identifier of a sending device will be embedded in each file sent from one of the plurality of devices to another of the plurality of devices.

Also, a unique file identification will be embedded in each file sent from one of the plurality of devices to another of the plurality of devices.

The system 100 also provides for the registration of a purchaser or other rights owner of a selected file in a database such as 116 or 118 via a registration server such as 112 or 114, to establish proof of ownership of rights in the selected file. Thus the uniquely identified file is associated with the rights owner and the database thereby establishing property rights in the rights owner.

The use of multiple registration servers with accompanying databases permits the classification of files by format of file content and the registration of purchaser and file identification data for a first format in a first database and registering of purchaser and file identification for a second format in a second database.

Assignment of Unique and Persistent File Identifiers and Embedding of Same by Watermarking.

The unique file identification is preferably assigned using a system such as the Handle System® developed by the Corporation for National Research Initiatives (CNRI), the details of which are incorporated herein by reference. The Handle System® provides identifiers for digital objects and other resources in distributed computer systems. These identifiers are known as handles. The system ensures that handles are unique and that they can be retained over long time periods. Since the system makes no assumptions about the characteristics of the items that are identified, handles can be used in a wide variety of systems and applications.

Digital Object Architecture provides a means of managing digital information in a network environment. A digital object has a machine and platform independent structure that allows it to be identified, accessed and protected, as appropriate. A digital object may incorporate not only informational elements, i.e., a digitized version of a paper, movie or sound recording, but also the unique identifier of the digital object and other metadata about the digital object. The metadata may include restrictions on access to digital objects, notices of ownership, and identifiers for licensing agreements, if appropriate.

The Handle System® is a general purpose distributed information system that provides efficient, extensible, and secure identifier and resolution services for use on networks such as the Internet. It includes an open set of protocols, a namespace, and a reference implementation of the protocols. The protocols enable a distributed computer system to store identifiers, known as handles, of arbitrary resources and resolve those handles into the information necessary to locate, access, contact, authenticate, or otherwise make use of the resources. This information can be changed as needed to reflect the current state of the identified resource without changing its identifier, thus allowing the name of the item to persist over changes of location and other related state information.

The Handle System® has the following components: naming authorities, handle generators, the global handle server, local handle servers, caching handle servers, client software libraries, proxy servers, and administrative tools. For reasons of performance and availability, the global, local, and caching servers are implemented as distributed systems comprising many server computers.

One suitable Handle System® based system for secure distribution of files such as audio files is that recently announced by Gibson Guitar Corp. of Nashville, Tenn., the assignee of the present invention, and referred to as the Take Anywhere® system. In accordance with the Take Anywhere® system several levels of such unique identifiers are generated in connection with the creation, distribution and sale of a typical audio file. First, upon creation of the digital master work a Handle System® based master identification is created and assigned to that master work. Then upon creation of digital copies of the work for distribution, a Handle System® based copy identification is created and assigned to each copy. The copy identification is derived from the master identification. Finally, when specific copies are sold to a purchaser, the specific rights or license granted to that purchaser are defined in a rights statement file which is maintained for example on one of the Registration Servers 112 or 114. That rights statement file has a Handle System® based rights registration identification assigned to it. The rights registration identification is also derived from the master identification.

The copy identification and the rights registration identification are preferably embedded in the digital copy through an embedded watermarking technology such as Verance Consensus available from Verance Corporation of San Diego, Calif. The Verance technology is described for example in the following U.S. patents which are incorporated herein by reference: U.S. Pat. Nos. 7,159,118; 7,046,808; 7,024,018; 6,912,315; 6,737,957; 6,683,958; 6,430,301; 6,427,012; and 6,145,081.

A call home function can be embedded in the file at the time of manufacture, so that when the file is transferred over a communication system there will be a call placed from one of the involved devices to the registration server to confirm that the copying, playing or other transaction is authorized by the rights statement associated with that file.

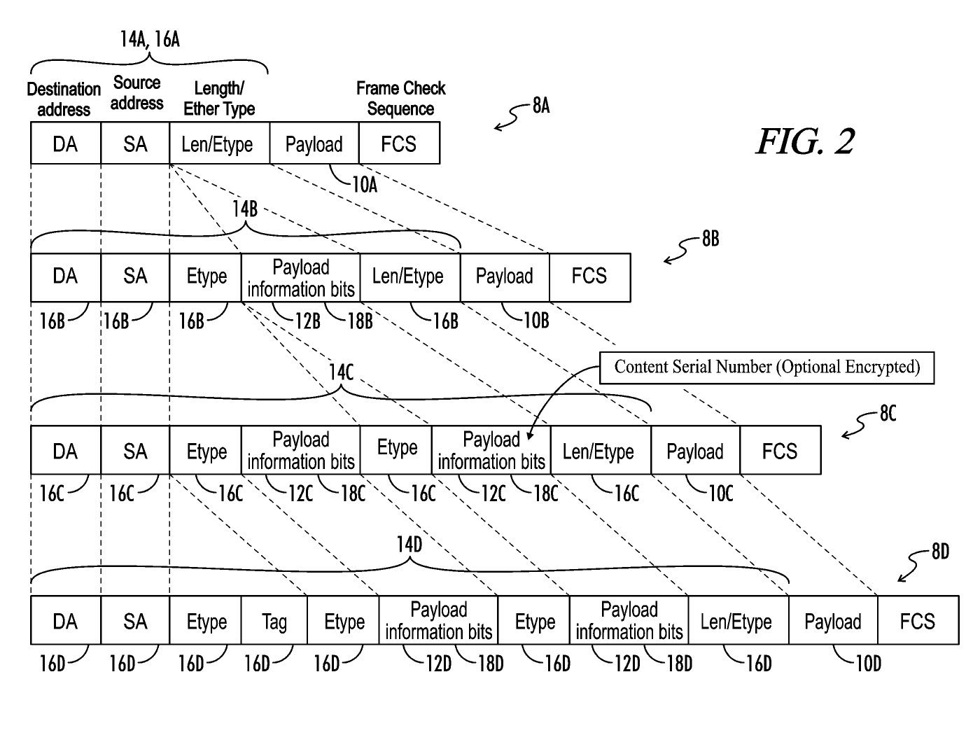

Embedding of Sending Device Identification and File Identification in Packet Headers per FIGS. 2-5

Another method for embedding such unique device identifiers and file identification is illustrated in FIGS. 2-5. The following description of FIGS. 2-5 is taken from copending U.S. patent application Ser. No. 11/613,434 of Juszkiewicz et al. entitled “Data Packet, Method, And Device of Transmitting Payload Information Within Extendable Header”, filed Dec. 20, 2006, the details of which are incorporated herein by reference.

This approach proposes adapting and expanding standard networking and communication protocols such as the Ethernet protocol for example to carry, transfer, and utilize information specific to the payload at the lower networking layers such as the data link layer where important networking and switching decisions are made. The OSI Reference Model For Network Communication defines seven different layers of distinct and separate functionality. These layers are the physical layer, the data link layer, the network layer, the transport layer, the session layer, the presentation layer and the application layer. Most packet oriented communication protocols are designed with a packet header section that carries all the information implementing the first six layers defined in the OSI Reference Model and a payload section that carries the information related to the application layer implementation. Upon transferring information from a source to a destination, intermediate systems only utilize the lower three layers of the OSI protocol, the physical layer, the link layer and the network layer, to transfer data packets between systems. According to the standard, these layers primarily contain information on how to transfer a data packet to the destination from the source. Nowhere has the standard reference model or the most widely deployed implementations based on it such as the Ethernet standard heavily used to carry Internet traffic provided fields to contain information about the payload carried by each data packet in the lower layers.

In the past this shortcoming was not critical since the original function of the Internet was to transfer time insensitive text files. Thus a user did not care whether his email or even static images were received in a halting asynchronous manner. In addition, the original designers of the Internet gave little thought to Internet piracy and the consequences of permitting a user to transfer information across the Internet anonymously. What is required is a method and/or device which can provide information about the payload of the data packet that may be optionally utilized to identify the packets of certain application for special treatment by the network. The information required may also include information related to the source of the data packet and other information that may be utilized to facilitate the assertion and possible enforcement of intellectual property rights of the data being carried by the network at the data link level. The data link layer provides the functional and procedural means to transfer data between network entities. In fact, normally network entities are only concerned with the information in the data link layer or the network layer in order to transfer the packet to the destination. The information for the data link layer is contained within a data packet header. If one could provide a limited amount of critical application specific information in the packet header, networking devices could optionally use this data to get involved in policing the network traffic for pirated or illegal transfers of information that is transferred through the web or setting priorities of transfer according to the types of information that are forwarded by the network. Unfortunately most communications standards do not have provisions to perform this function. In fact, no field in the IEEE Ethernet protocol standard specifically provides for space to input the necessary information. Ethernet was designed to treat all packets anonymously and equally. In the past this was acceptable since all packets carried text data with weak ownership claims and intellectual property rights attached to them. This is no longer ideal for today's network that carries strongly owned audio, video, and other time sensitive media type data. This innovation focuses on creating provisions with the existing and widely adopted networking standards such as Ethernet for identifying certain networking traffic types for special treatment including but not limited to making deterministic forwarding decisions and prioritization decisions.

Referring now to FIG. 2, data packets 8A, 8B, 8C and 8D comprising payloads 10A, 10B, 10C and 10D and extendable headers 14A, 14B, 14C and 14D are shown. Each data packet 8A, 8B, 8C and 8D in FIG. 2 represents the same data packet except for the extension of the header. As is shown in the drawings, extendable headers 14A, 14B, 14C and 14D have at least one packet handling field 16A, 16B, 16C, 16D. Packet handling fields contain information normally present in the data link layer. As is shown, this information can consist of destination addresses, source addresses, and Ethernet type fields describing the presence and function of fields within the data link layer. Data packets 8B, 8C and 8D are a representation of data packet 8A wherein the header 14A has been extended by at least one payload information field 18 for containing the payload information bits 12. By extension of the header the applicant does not intend to imply that the data packet must first be in a short frame and then extended into a longer frame. While this is included in the definition, it is not the only definition of extension. Extension is also utilized in this application as configuring the creation of the data packet in an extended state. Referring specifically to data packets 8B, 8C and 8D, the extendable headers 14B, 14C and 14D are extended such that the payload information bits 12B, 12C and 12D are contained within the payload information fields 18B, 18C and 18D of the headers 14B, 14C and 14D.

In order to provide policing functions, in addition to a plethora of other functionality, the payload information bits 12B, 12C and 12D may include a content serial number. A content serial number is a unique identification describing the contents of the payload 10A, 10B, 10C and 10D. Normally, these content serial numbers will be created by an industry to standardize the meaning of the numbers chosen. In this manner, networking devices can be configured to listen for payload information bits 12B, 12C and 12D contained within the extendable headers 14B, 14C and 14D. The networking devices can thus become involved in making decisions about the transfer and manipulation of the information. Furthermore, the networking devices can inform other systems of the presence of certain types of information. Thus, this data packet configuration provides a method of policing piracy. If certain media content is being transferred from one system to another a networking device can be configured to listen for payload information bits 12B, 12C and 12D within the extendable headers 14B, 14C and 14D. In this manner, appropriate systems can be informed of the transfer and determine whether the transfer was authorized.

Payload information bits may also include a MAC address. A MAC address is a number provided to a networking device by the manufacturer of the networking device. The number consists of 48 bits and is always unique to the specific piece of equipment. By providing the MAC address within the payload information bits 12B, 12C and 12D, the MAC address will indicate the source of the content. This eliminates the anonymity of the web and permits the tracking of a message to a particular source.

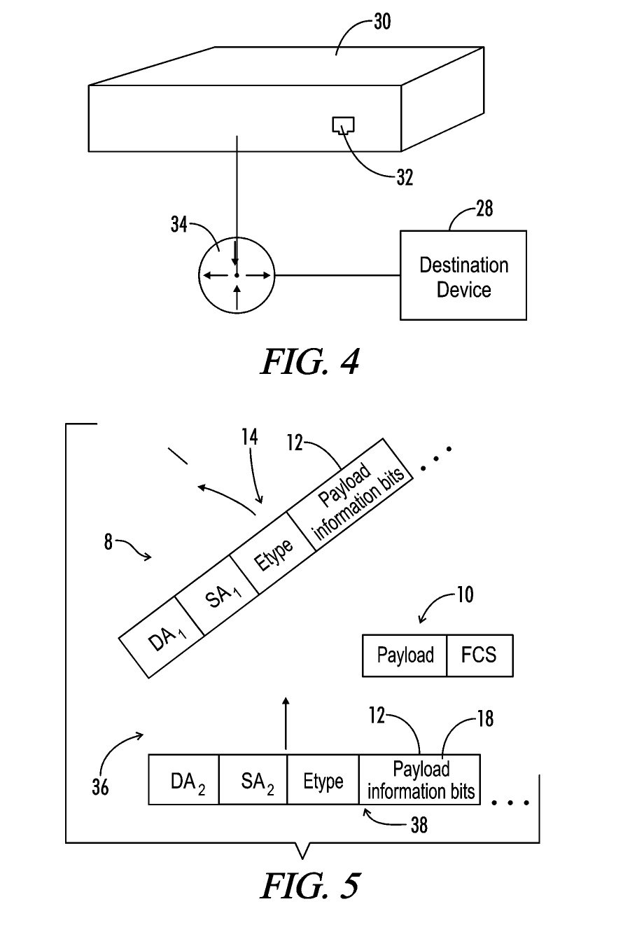

To illustrate an example of the utilization of the data packets 8B, 8C and 8D, and extendable headers 14B, 14C and 14D with payload information bits 12B, 12C and 12D, the payload information bits 12B, 12C and 12D can be utilized to determine a priority of transmission for the data packets 8B, 8C and 8D according to the payload information bits 12B, 12C and 12D. Referring now to FIG. 4, the data packet 8 is transmitted for transmission to a destination device 28. In most instances, the data packet 8 is received at an intermediary network device 30. Intermediary network is any device which provides functionality for getting the data packet 8 to the destination device 28. Such devices include servers, routers, hubs, and switches. Once received at an intermediary network device 30, the contents of the data packet 8 are determined from the payload information bits 12. Thus, as an example, if the payload information bits 12 contain a content serial number, the device can determine a priority of transmission according to the contents of the payload 10. After a priority of transmission is determined, the data packet 8 is transmitted from the intermediary network device 30 for transmission to the destination source 28 according to the priority of transmission.

Specifically, the payload 10 of the data packet 8 may contain audio-video content. The payload information bits thus may contain a content serial number indicating that the payload 10 contains audio-video content and also a MAC address indicating the source of the audio-video content. In this manner, according to the source of the audio-video content and the fact that the device is transmitting audio-video content, the device can set a high priority for transmission of the information. This is particularly important in the transfer of audio-video content since asynchronous delivery of the information results in inappropriate delivery of the information.

As another example of the utilization of the data packet, one can determine whether to forward the data packet 8 to the destination device 28 according to the payload information bits 12. Thus, again, one would transmit the data packet 8 for transmission to a destination device 28. An intermediary network device 30 would receive the data packet 8. Payload information bits 12 would be extracted from the extendable header 14. The data packet 8 would be transmitted from the intermediary network device to the destination device if forwarding is appropriate. For example, one may be reading the payload information bits 12 to determine the contents of the payload 10. If the payload 10 is a copyrighted song, a determination of whether the transfer is authorized can be determined before the transfer is made. Thus the transfer of any private or proprietary information can be controlled through the utilization of the data packet 8.

Of course, devices not configured to listen for payload information bits 12 within the extendable header 14 will simply ignore these fields and transfer the data packet without reference to the additional information. However, to achieve the functionality desired in this application a device will need to be configured to listen for the payload information bits 12 within the extendable header 14. Referring now to FIG. 4 this device will normally require a port 32 for receiving the data packet 8 and a packet processor 34. The packet processor is configured to extract the payload information bits 12 from the extendable header 14. One method of configuring the packet processor 34 is by providing a gateway with a group of content switches that will be configured to look for the payload information fields 18 within the extendable header 14. In the preferred embodiment, the packet processor 34 is capable of setting up priority of transmission according to the payload information bits 12. In addition, the packet processor 34 can make forwarding decisions based on the payload information bits 12.

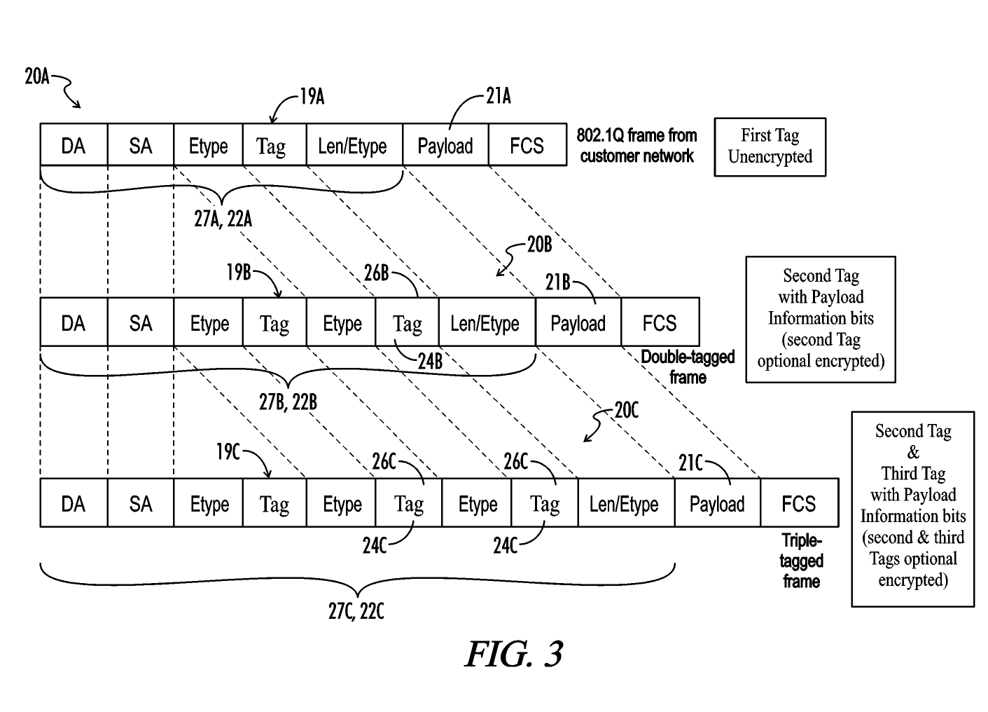

Referring now to FIG. 3, a specific embodiment of the invention formatted according to the IEEE 802.1Q is shown. As discussed previously, data packets 20A, 20B and 20C contain extendable headers 27A, 27B and 27C and payload 21A, 21B, and 21C. Headers 27A and 27B of data packet 20 are extendable because IEEE 802.1Q allows for providing tag frames 22A, 22B and 22C for data packets 20A, 20B and 20C. Normally, tag frames 22A, 22B and 22C are utilized to specify a location in a virtual local area network. Consequently, in any data packet formatted according to the IEEE 802.1Q the first tag 19A, 19B and 19C must contain a VLAN ID, not payload information bits. This VLAN ID specifies a particular system in the virtual local area network. However, this VLAN ID is limited to a certain number of bytes and thus the IEEE 802.1Q extendable header format was provided in order to allow for additional tags so that systems containing more nodes than are available for identification by a single VLAN ID could be specified. However, instead of utilizing the tags to specify a system on a virtual local area network, this invention proposes utilizing the additional tags to contain payload information bits 26B and 26C. Thus, the data packets 20B and 20C are configured with sufficient additional tags 24B and 24C to contain the payload information bits 26B and 26C. The payload information bits 26B and 26C are provided within the additional tags 24.

Referring now to FIGS. 4 and 5, a method of transmitting the data packet 8 from the intermediary network device 30 to the destination device 28 is shown. In normal circumstances, intermediary networking device 30 removes the extendable header 14 from the data packet 8 in order to process routing for the device. In order to transfer the information, the intermediary network device 30 creates a second transmission data packet 36 which has a second extendable header 38 and the payload 10, and is the data packet transmitted from the device. This second extendable header 38 is also extended such that the payload information bits 12 fit within the second extendable header 38. The payload information bits 12 are also provided within the second extendable header 38. In this manner the information is transmitted, by transmitting the transmission data packet 36 from the intermediary network device 30.

Thus it is seen that the system and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. A method of operating a secure communication system, the system including a plurality of devices capable of sending and receiving files, the method comprising:
(a) embedding a unique identifier of a sending device in each file sent from one of said plurality of devices to another of said plurality of devices;
(b) embedding a unique file identification in each file sent from one of said plurality of devices to another of said plurality of devices; and
(c) registering a rights owner of a selected uniquely identified file in a database via a registration server to establish proof of rights in the selected uniquely identified file, so that the selected uniquely identified file is associated with the rights owner in the database thereby establishing property rights in the rights owner.

2. The method of claim 1, wherein:
in step (a), the unique identifier of the sending device includes the MAC address of the sending device.

3. The method of claim 1, further comprising:
sending each file from its respective sending device to its respective receiving device over the worldwide web; and
preserving the embedded unique identifier of its respective sending device in each file through the entire journey from its respective sending device to its respective receiving device, thereby eliminating anonymity of the sending device.

4. The method of claim 1, wherein:
step (b) comprises embedding the unique file identification in the file stored in a physical medium.

5. The method of claim 1, wherein:
step (b) comprises embedding the unique file identification in a virtual file to be downloaded to the purchaser.

6. The method of claim 1, wherein:
in step (c), identifying information regarding the rights owner is maintained in confidentiality.

7. The method of claim 1, wherein the files comprise audio files.

8. The method of claim 1, wherein:
step (c) comprises classifying files by format of file content and registering rights owner and file identification data for a first format in a first database, and registering rights owner and file identification data for a second format in a second database.

9. The method of claim 1, further comprising:
in response to sending a file from one of said plurality of devices to another of said plurality of devices, transmitting a transfer notification message to the registration server.

10. The method of claim 9, further comprising:
monitoring the transfer notification messages for fraudulent activity.

11. The method of claim 1, further comprising:
in response to playing a file on one of said plurality of devices, transmitting a play notification message to the registration server.

12. The method of claim 11, further comprising:
monitoring the play notification messages to track volume of file usage.

13. The method of claim 12, wherein:
the files of steps (a) and (b) include commercials having separate file identification; and
the monitoring step includes separately monitoring commercial viewership.

14. A method of communicating a file from a sending device to a receiving device, comprising:
(a) embedding a unique identifier of the sending device in the file;
(b) embedding a unique file identification in the file;
(c) sending the file, with the unique identifier and the unique file identification embedded therein, from the sending device to the receiving device; and
(d) registering a rights owner of the file with a registration server and associating the rights owner with the unique file identification.

15. The method of claim 14, wherein:
in step (a), the unique identifier of the sending device includes the MAC address of the sending device.

16. The method of claim 14, wherein:
step (c) comprises sending the file via a global communication system; and
further comprising, preserving the embedded unique identifier of the sending device through the entire journey from the sending device to the receiving device, thereby eliminating anonymity of the sending device.

17. The method of claim 14, wherein:
in step (a), the file comprises audio data; and
in step (c), the file is transmitted using the MaGIC® protocol.

18. The method of claim 14, further comprising:
in response to step (c), transmitting a transfer notification message to the registration server.

19. The method of claim 18, further comprising:
monitoring the transfer notification message for fraudulent activity.

20. The method of claim 14, further comprising:
playing the file in one of the devices;
transmitting a play notification message to the registration server; and
monitoring the play notification message to track volume of file usage.
